(19) United States
(12) Patent Application Publication
(10) Pub. No.: US 2019/0122780 A1
(43) Pub. Date: Apr. 25, 2019

(54) TARGET, TARGET PRODUCTION METHOD, AND NEUTRON GENERATION DEVICE

(71) Applicant: Kaneka Corporation, Osaka (JP)

(72) Inventors: Mutsuaki MURAKAMI, Osaka (JP); Atsushi TATAMI, Osaka (JP); Masamitsu TACHIBANA, Osaka (JP)

(73) Assignee: Kaneka Corporation, Osaka (JP)

(21) Appl. No.: 16/092,986

(22) PCT Filed: Apr. 20, 2017
(86) PCT No.: PCT/JP2017/015906

§ 371 Date: Oct. 11, 2018

(30) Foreign Application Priority Data
Apr. 21, 2016 (JP) 2016-085302

(51) Int. Cl. G21G 4/02; G21K 5/04; G21K 5/08

(52) U.S. Cl. CPC G21G 4/02; G21K 5/08; G21K 5/04

(57) ABSTRACT

Provided is a target that is sufficiently durable and sufficiently heat-resistant for use as a target for an accelerator and that can reduce the extent of radioactivation. A target (A) of the present invention includes: a metal film (3); and a substrate constituted by a graphite film (4). The graphite film (4) has a thermal conductivity in a surface direction of 1600 W/(m·K) or greater, the thermal conductivity in the surface direction of the graphite film (4) is equal to or greater than 100 times a thermal conductivity in a thickness direction of the graphite film (4), and the graphite film (4) has a thickness of 1 μm or greater and 100 μm or less.

### TECHNICAL FIELD

The present invention relates to a target, a method of producing a target, and a neutron generator.

### BACKGROUND ART

Neutrons are used in, for example, studying crystal structure or magnetic structure of substances based on a neutron beam diffraction phenomenon caused by crystals, or in medical applications such as cancer therapy. In particular, boron neutron capture therapy (BCNT), which is a selective cancer therapy, has been promising in recent years, and this increases the importance of neutron generators used for those purposes. For example, Patent Literature 1 discloses an accelerator neutron source for neutron generation for boron neutron capture therapy. The accelerator neutron source disclosed in Patent Literature 1 includes: a metal target in a plate shape for irradiation with a charged particle beam (proton beam); and a cooling apparatus for cooling the metal target. In this accelerator neutron source, the metal target in a plate shape is irradiated with a charged particle beam accelerated by the accelerator, and thereby neutrons are generated. The metal target is cooled by the cooling apparatus.

A target for neutron generation by irradiation with a proton beam is disclosed by, for example, Patent Literatures 2 to 5. The targets disclosed in Cited Literatures 2 to 5 are composite targets each composed of: a non-metal material; and beryllium or lithium. The non-metal material used is isotropic high-density graphite.

### CITATION LIST

### Patent Literature

[Patent Literature 1]

Japanese Patent Application Publication, Tokukai, No. 2006-196353
[Patent Literature 2]

Japanese Patent Application Publication, Tokukai, No. 2012-119062
[Patent Literature 3]

Japanese Patent Application Publication, Tokukai, No. 2012-186012
[Patent Literature 4]

Japanese Patent Application Publication, Tokukai, No. 2012-243640
[Patent Literature 5]

Japanese Patent Application Publication, Tokukai, No. 2013-206726

### SUMMARY OF INVENTION

### Technical Problem

The conventional targets for neutron generation configured such that a metal target is disposed on a substrate as described above, however, have issues in that they have poor durability and poor heat resistance against proton beams.

A proton beam, after entering a metal target, induces generation of a huge quantity of heat, usually as much as 10 to 20 MW/m² or greater, within the metal target. That is, a substrate that supports the metal target and that is made of a non-metal material is required to be highly durable and highly heat-resistant against charged particle beam irradiation. However, conventional materials for a support substrate are far from sufficient in terms of durability and heat resistance against proton beam irradiation.

Furthermore, especially in a case where the quantity of heat generated by irradiation with a high-energy proton beam is extremely large, usually a target including a cooling mechanism (for example, a flow channel for passage of cooling water) is used. The metal plate including a cooling mechanism is made of aluminum. The half-life of aluminum is 300,000 years, which means that aluminum becomes radioactive to an extremely large extent. Highly radioactive targets cannot be handled by humans. This leads to difficulty in irradiation with high-energy proton beams and continuous use of the beams.

Study has been done on use of a target substrate made of a carbon material that does not easily become radioactive, in order to reduce such radioactivation. Patent Literatures 2, 4, and 5 disclose specific examples of such a carbon material, such as isotropic graphite materials, single-crystal graphite, HOPG, glassy carbon, single-crystal diamond, and epitaxial diamond. However, a target for neutron generation in reality is required to be large enough for actual use, that is, for example, the target needs to be about 10 mm to 500 mm in diameter. From this point of view, it is apparent that, among the examples of carbon materials disclosed in the above patent literatures, materials such as single-crystal graphite, HOPG, single-crystal diamond, and epitaxial diamond are not suitable for practical use in terms of necessary area, unavailability, price, and the like. On the other hand, in regard to isotropic graphite and glassy carbon, these materials having the foregoing necessary area are obtainable; however, the thermal conductivity of these materials, even that of isotropic graphite, is, at most, 70 to 150 W/mK, and that of glassy carbon is about 10 W/mK. Therefore, heat is built-up in the substrate and causes temperature rise, resulting in reduction in durability. To prevent this, it is necessary to increase the thickness of the substrate. In a case of a substrate made of isotropic graphite, the substrate needs to be about 2 mm to 50 mm in thickness. The necessary thickness of such an isotropic graphite substrate is selected in view of durability and in view of its role as a fast neutron moderator to moderate fast neutrons harmful in cancer therapy.

The present invention was made in view of the above issues, and an object thereof is to provide a target that is much thinner than conventional targets, that is sufficiently durable and sufficiently heat-resistant against a large quantity of heat generated by proton beam irradiation, and that can reduce the extent of radioactivation, a method of producing a target, and a neutron generator.

### Solution to Problem

A target of one aspect of the present invention includes, at least: a metal film composed of a beryllium material or a lithium material; and a substrate constituted by a graphite film, the target being configured to generate a neutron upon collision of an accelerated proton with a surface of the metal film and a surface of the substrate, the graphite film having a thermal conductivity in a surface direction of 1500 W/(m·K) or greater, the thermal conductivity in the surface direction of the graphite film being equal to or greater than 100 times a thermal conductivity in a thickness direction of the graphite film, the graphite film having a thickness of 1 μm or greater and 100 μm or less.

A method of producing a target of another aspect of the present invention is a method of producing a target that includes: a metal film composed of a beryllium material or a lithium material; and one or more graphite films composed of graphite, the target being configured to generate a neutron upon collision of a proton with a surface of the metal film and a surface of the graphite film, the method including a step of preparing the one or more graphite films by firing one or more polymeric films.

### Advantageous Effects of Invention

A target of one aspect of the present invention is sufficiently durable and sufficiently heat-resistant against proton beam irradiation, brings about the effect of being able to reduce the extent of radioactivation, and, in addition, can be reduced in thickness to a much greater extent than conventional targets. This makes it possible to generate, by use of a proton beam accelerated only to an energy lower than conventional, low-energy thermal and epithermal neutrons suitable for medical applications such as cancer therapy.

### BRIEF DESCRIPTION OF DRAWINGS

FIG. 1 is a cross-sectional view schematically illustrating a configuration of a target (A) in accordance with Embodiment 1 of the present invention. An a-b face of a graphite film extends along a surface direction of a target substrate, and heat diffuses in the surface direction.

FIG. 2 is a cross-sectional view schematically illustrating a configuration of a target (B) in accordance with Embodiment 1 of the present invention. The target (B) includes a frame mechanism for support.

FIG. 3 is a cross-sectional view schematically illustrating a configuration of a target (C) in accordance with Embodiment 1 of the present invention. The target (C) includes a frame structure for support and a cooling mechanism.

FIG. 4 is a cross-sectional view schematically illustrating a configuration of a target (D) in accordance with Embodiment 1 of the present invention.

FIG. 5 is a graph showing the relationship between the stopping power based on the Bethe equation (equation (3)) and kinetic energy of particle.

FIG. 6 is a cross-sectional view schematically illustrating a configuration of a target substrate (E) whose thickness is controlled by stacking a plurality of graphite films.

### DESCRIPTION OF EMBODIMENTS

### Embodiment 1

As described earlier, conventionally used materials for a substrate for supporting a metal target are carbon materials, isotropic graphite, aluminum (Al), and the like. In particular, graphite, which becomes radioactive only to a relatively small extent and which is resistant to heat (3000° C.) in vacuum, is an ideal material, and isotropic graphite materials have been conventionally used as carbon substrates. However, isotropic graphite substrates are far from sufficient in terms of durability and heat resistance against high-energy proton beams for the foregoing reasons, and there has been a strong demand for targets with higher durability.

In view of this, the inventors came up with an idea of quickly diffusing heat generated on a target substrate by imparting anisotropy to the thermal conductivity characteristics of a graphite material and thereby increasing the thermal conductivity in a surface direction of the target. The inventors studied hard in an attempt to develop a support substrate that prevents temperature rise of the target substrate by the above process and that is sufficiently durable and sufficiently heat-resistant against proton beam irradiation.

As a result, the inventors succeeded in developing a support substrate that can reduce the extent of radioactivation and that has sufficient durability and sufficient heat resistance against proton beam irradiation, by employing graphite having specific properties and certain dimensions. Specifically, temperature rise of a substrate is prevented by quickly diffusing generated heat by imparting anisotropy to the thermal conductivity characteristics of graphite and thereby increasing the thermal conductivity in a surface direction of the target.

Such a graphite substrate of an embodiment of the present invention was found to be sufficiently durable to serve as a target substrate, despite that it is a thin film much thinner than the substrate thickness required for conventional isotropic graphite substrates and the like. The greatest benefit of a thin target substrate is that low-energy, less-harmful thermal and epithermal neutrons can be efficiently generated by irradiation with a proton beam accelerated only to an energy lower than conventional. Such thermal and epithermal neutrons are useful for medical applications such as cancer therapy. The second benefit of using a proton beam accelerated only to a low energy is that the extent of radioactivation of the target by the proton beam can be reduced, and the third benefit is that the accelerator itself can be reduced in size.

It is natural to think that as the energy of an accelerated proton beam lowers, the quantity of heat generated due to such beam irradiation also decreases. However, this does not apply in a case of heat generation caused by irradiation with an accelerated beam. In the case of heat generation caused by irradiation with an accelerated beam, completely the same level of heat resistance is required both in a case of a proton beam accelerated only to a low energy and in a case of a proton beam accelerated to a high energy. The reason therefor will be described later in detail (in “Energy of accelerated proton beam and heat generation” section). Briefly, a reduction in thickness of a graphite substrate leads not only to a reduction in mechanical strength but also to an increase in heat load per unit volume induced by proton beam irradiation. This results in requirements of the same level of durability and heat resistance both in the case of a proton beam accelerated only to a low energy and in the case of a proton beam accelerated to a high energy. Therefore, it has been thought that thin carbon or thin graphite is not enough to serve as a neutron generation substrate.

The inventors, however, did several researches on their own and established a technique to produce a graphite film that has excellent properties such as excellent thermal conductivity. The inventors also found that the mechanical strength that is enough to serve as a substrate can be achieved, provided that the range of from 100 μm to 1 μm is satisfied.

The inventors did a further research and newly found that, surprisingly, this graphite film can withstand the heat load generated by irradiation with a proton beam, despite being 100 μm or less in thickness. The reason why such a very thin graphite film has high heat resistant characteristics equivalent to those of a thick film appears that heat dissipation is achieved not only by heat conduction of a solid but also by a great heat dissipation effect by radiation, which can effectively cool a thin graphite film with small heat capacity.

Use of such a thin target enables use of a proton beam accelerated only to a low energy (about 2 MeV to 6 MeV), as described earlier. This makes it possible to reduce the extent of radioactivation of the target. Furthermore, since a neutron beam produced with the use of such protons accelerated only to a low energy does not contain harmful fast neutrons, a neutron generation target or apparatus using such a neutron beam are suitable for medical use such as cancer therapy. The technical idea of the present invention based on the above finding reverses conventional findings, and is not the one that is predictable from conventional findings but the one that has been accomplished by the inventors themselves.

The following description will discuss embodiments of the present invention in detail.

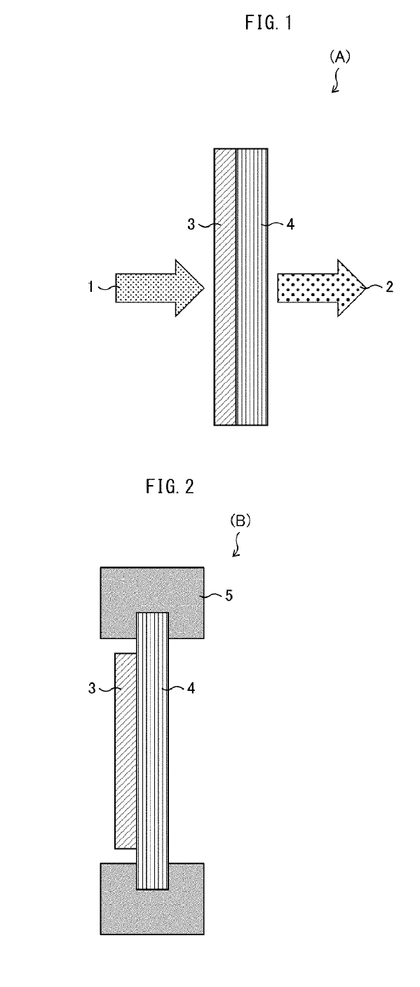

As illustrated in FIG. 1, a target (A) in accordance with Embodiment 1 is constituted by a metal film 3 and a graphite film 4, and is configured to generate a neutron 2 upon collision of a proton beam 1 with a surface of the metal film 3 and a surface of the graphite film 4. A surface of the metal film 3 and the surface of the graphite film 4 constitute the interface between the metal film 3 and the graphite film 4. This makes it possible to allow heat of nuclear reaction, generated by the collision of the proton beam, to be shared by two materials.

(Metal Film 3)

The metal film 3, whose surface collides with the proton beam, is composed of a beryllium material or a lithium material. With this configuration, the metal film 3 is capable of generating a low-energy neutron 2 upon collision with a low-energy proton beam.

Specifically, in a case where the metal film 3 is composed of a beryllium material, it is possible to allow the metal film 3 to undergo the ⁹Be(p,n) nuclear reaction upon collision with a proton beam of 3 MeV to 11 MeV. In a case where the metal film 3 is composed of a lithium material, it is possible to allow the metal film 3 to undergo the ⁶Li(p,n) nuclear reaction or the ⁷Li(p,n) nuclear reaction upon collision with a proton beam of 2 MeV to 4 MeV.

As used herein, the term “beryllium material” refers to a single element material of beryllium element, a beryllium compound, a beryllium alloy, or a beryllium composite material. As used herein, the term “lithium material” refers to a single element material of lithium element (metal consists only of lithium element, hereinafter referred to as lithium), a lithium compound, a lithium alloy, or a lithium composite material. The reason why beryllium, beryllium compounds, beryllium alloys, and beryllium composite materials are collectively referred to as “beryllium materials” and lithium, lithium compounds, lithium alloys, and lithium composite materials are collectively referred to as “lithium materials” is that the principle of neutron generation is based on a nuclear reaction that is specific to a specific element. That is, the principle of neutron generation caused by irradiation of a target with an accelerated proton beam is based on a physical nuclear reaction between the proton beam and atoms of a specific element contained in the target, and thus, also in a case where the target is composed of a compound of the specific element or a composite material of the specific element, the neutrons are generated through a similar nuclear reaction to the case of a simple substance of the specific element. That is, in an embodiment of the present invention, beryllium compounds, beryllium alloys, beryllium composite materials, lithium compounds, lithium alloys, and lithium composite materials can be used, as well as beryllium and lithium. In a case where a compound or composite material of the foregoing specific element (beryllium element or lithium element) is used as a target material, it is preferable that the elements other than the specific element contained in the compound or the composite material are those which are not radioactivated by protons or neutrons or which do not produce any harmful substance through the reaction with by-product hydrogen atoms. Examples of such elements include, but are not limited to, carbon, silicon, nitrogen, phosphorus, oxygen, and sulfur.

The opposite side of the metal film 3 from the graphite film 4 faces the direction of travel of protons. Such an arrangement achieves the following: when a metal film 3 having a thickness that is thinner than the theoretical range of proton is employed, some protons undergo a nuclear reaction while passing through the metal film 3 and other protons undergo a nuclear reaction while passing through the graphite film 4. With this arrangement, the heat load resulting from the nuclear reactions does not concentrate in one material. This makes it possible to reduce the heat load that the materials experience.

The metal film 3 of the target (A) can have a thickness that is much less than the theoretical range of proton in beryllium or lithium. This is because the graphite film 4 serves to support and cool the metal film 3 and thereby the heat loads that the metal film 3 and the graphite film 4 experience are reduced.

For example, the theoretical range of proton of 11 MeV in beryllium is about 0.94 mm. Therefore, in a case where a target substrate consists only of a metal film 3 made of a beryllium material, the metal film 3 made of a beryllium material is required to be equal to or greater than 1 mm in thickness. In contrast, the metal film 3 of the target (A) in accordance with Embodiment 1 can have a thickness much less than 1 mm. In a case where the metal film 3 is made of a beryllium material, the thickness of the metal film 3 is preferably equal to or greater than 10 μm and less than 1 mm, more preferably equal to or greater than 20 μm and less than 0.5 mm. A metal film 3 less than 10 μm in thickness has a decreased heat resistance.

The theoretical range of proton of 1 MeV in lithium is about 2 mm. Therefore, in a case where the metal film 3 is made of a lithium material, the metal film 3 of the target (A) can have a thickness much less than 2 mm. In a case where the metal film 3 is made of a lithium material, the thickness of the metal film 3 is preferably equal to or greater than 10 pm and less than 1 mm, more preferably equal to or greater than 20 μm and less than 0.5 mm. A metal film 3 less than 10 μm in thickness has a decreased heat resistance.

The area of the surface of the metal film 3 irradiated with proton can be determined appropriately depending on the power setting of the proton. Usually, the maximum value of heat load per unit area of a target substrate is represented by a value obtained by dividing the output power of proton by the area irradiated with the proton. Thus, the metal film 3 is designed such that its ability to release heat from a surface is equal to or greater than the heat load that the target (A) experiences. For example, the output power of proton necessary for generation of neutron for medial use such as BNCT is calculated to be about 30 kW at maximum. Therefore, assuming that, for example, the area of a surface of a metal film serving as a target is 30 cm², the heat load is calculated to be about 10 MW/m². This heat load is equivalent to heat that raises the temperature of beryllium by about 3000° C. per second, in a case where the metal film serving as a neutron generation target is a beryllium film having a thickness of 1 mm and a surface area of 30cm².

The surface area of the metal film 3 is preferably equal to or larger than a plane area perpendicular to the direction of travel of proton, for reducing the foregoing large heat load. For example, in a case where the surface area of the metal film 3 is twice as large as the plane area perpendicular to the direction of travel of the proton, the heat load per unit plane area of the metal film 3 irradiated with the proton is reduced to equal to or less than one-half. The surface area of the metal film 3 can be increased, for example, by imparting irregularities to the surface of the metal film 3, by causing a graphite film 4 having irregularities on its surface and serving as a substrate to support the metal film 3, by coating powder on the metal film 3, or the like method. In a case where the metal film 3 is composed of a beryllium material, the surface of the beryllium material can be fabricated by, for example, laser ablation, etching, molding, or the like method. As used herein, the term “plane area” refers to the area of proton beam spot on a surface of the metal film 3, assuming that the surface is flat. As has been described, in Embodiment 1, neutrons are generated through collision of low-energy protons with the target (A), which is constituted by the metal film 3 and the graphite film 4. In a case where the metal film 3 is composed of a beryllium material, the nuclear reaction ⁹Be(p,n) takes place in the metal film 3 of the target (A). In a case where the metal film 3 is composed of a lithium material, the nuclear reaction ⁶Li(p,n) or ⁷Li(p,n) takes place in the metal film 3 of the target (A). On the other hand, the nuclear reaction ¹²C(p,n) takes place in the graphite film 4 of the target (A).

(Graphite Film 4)

In Embodiment 1, a substrate that supports the metal film 3 (such a substrate is hereinafter also referred to as a target substrate) is a thin graphite film 4 that is equal to or greater than 1 μm and equal to or less than 100 μm in thickness. The graphite film 4 has a small heat capacity, and thus energy loss is reduced and neutron generation efficiency improves.

The graphite film 4 is suitable in order to reduce the extent of radioactivation resulting from incident protons and generated neutrons and to produce low-energy neutrons with a reduced amount of fast neutrons that are harmful and that have the high ability to cause radioactivation. Graphite is a material that is highly efficient in generating neutrons and that does not easily become radioactive, absorbs few thermal and epithermal neutrons, and is highly effective in decelerating neutrons.

The graphite film 4 only needs to have a thermal conductivity in a surface direction of 1500 W/(m·K) or greater and a thickness of 1 μm or greater and 100 μm or less. Other configurations of the graphite film 4 are not particularly limited. Such a graphite film 4 is preferred, because such a graphite film 4 has a mechanical strength necessary for a target and has a high thermal conductivity in the surface direction. As used herein, the term “thickness” refers to a dimension of the graphite film 4 along the direction of travel of proton.

The target (A), which is constituted by the foregoing metal film 3 and graphite film 4, is sufficiently durable and sufficiently heat-resistant against irradiation with the proton beam 1, despite that the target (A) is much thinner than conventional targets. This target is not so effective in decelerating generated neutrons. However, this makes it possible to obtain desired low-energy thermal and epithermal neutrons by irradiation with the low-energy proton beam 1.

In a case where the metal film 3 and a member near the metal film 3 have become radioactive, a worker is at a risk of exposure to radiation when the worker removes the target (A) from a neutron generator. Furthermore, in a case where these members become radioactive, disposal of these members as radioactive waste, for example, will be a problem. In this regard, according to a target of an embodiment of the present invention, neutrons can be generated with the use of a low-energy proton beam. This makes it possible to dramatically reduce the extent of radioactivation.

(Method of Producing Graphite Film 4)

A method of producing a graphite film 4 in accordance with Embodiment 1 is not particularly limited, and is, for example, a method of preparing a graphite film 4 by treating a polymeric film with heat (e.g., by firing a polymeric film). In this method, it is possible to prepare graphite in the form of a large-area film, and, for example, it is even possible to easily prepare a film having an area of 300 mm in diameter. Thus, this production method does not involve any issue from the practical point of view, as compared to carbon materials disclosed as target substrates in the foregoing Patent Literatures, such as HOPG, single-crystal graphite, and diamond.

A method of producing a graphite film 4 of one example of Embodiment 1 includes a carbonizing step including carbonizing an aromatic polyimide film and a graphitizing step including graphitizing the carbonized aromatic polyimide film.

<Carbonizing Step>

The carbonizing step involves carrying out carbonization by preheating an aromatic polyimide film, which is a starting material, under reduced pressure or in nitrogen gas. The heat treatment temperature for carbonization is preferably 500° C. or above, more preferably at 600° C. or above, most preferably 700° C. or above.

<Graphitizing Step>

In the graphitizing step, graphitization may be carried out after removing the carbonized polyimide film from a furnace and then transferring it to a graphitization furnace, or carbonization and graphitization may be carried out continuously. The graphitization is carried out under reduced pressure or in an inert gas. Suitable inert gases are argon and helium. The treatment may be carried out until the heat treatment temperature (firing temperature) reaches 2400° C. or above, preferably 2600° C. or above, more preferably 2800° C. or above.

During the carbonization process and graphitization process, wrinkles may appear. The wrinkles, however, are not an issue at all in applications of the present invention.

As described earlier, in a case where the graphite film 4 is used as a substrate for the target (A), the wrinkles in the graphite film 4 would rather contribute to an increase in surface area of the metal film 3, due to the irregular surface resulting from the wrinkles. It follows that the area irradiated with the proton beam 1 increases, and neutron generation efficiency increases. This is preferred.

According to the above method, it is possible to obtain a graphite film 4 that has good graphite orientation and good graphite crystallinity and that has excellent thermal conductivity.

A polymeric film for use in Embodiment 1 is a polymeric film of at least one polymer selected from aromatic polyimides, aromatic polyamides, polyoxadiazoles, polybenzothiazoles, polybenzobisthiazoles, polybenzoxazoles, polybenzobisoxasoles, polyparaphenylene vinylenes, polybenzimidazoles, polybenzobisimidazoles, and aromatic polythiazoles. A particularly preferable raw material film for the graphite film 4 of Embodiment 1 is an aromatic polyimide film.

(Thermal Conductivity in Surface Direction of Graphite Film 4)

The thermal conductivity in a surface direction of the graphite film 4 in Embodiment 1 is equal to or greater than 1500 W/(m·K), preferably equal to or greater than 1600 W/(m·K), more preferably equal to or greater than 1700 W/(m·K).

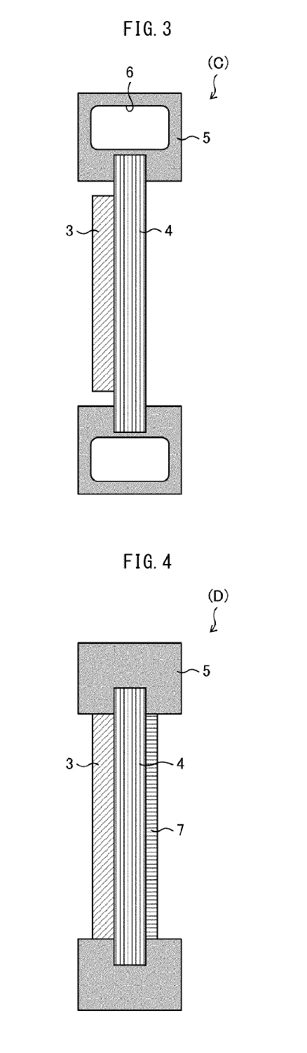

Use of a graphite film 4 having a thermal conductivity in the surface direction of 1500 W/(m·K) or greater provides multilayer graphite having a better heat dissipation performance. A graphite film 4 having a thermal conductivity in the surface direction of 1500 W/(m·K) or grater is much higher in thermal conductivity than the metal film 3, and therefore is capable of quickly diffusing, in the surface direction, heat generated in the metal film 3 and guiding the heat to a frame having a cooling function (refer to FIGS. 3 and 4).

Furthermore, the graphite film 4 preferably has anisotropy (orientation) such that the thermal conductivity in the surface direction of the graphite film 4 is equal to or greater than 100 times the thermal conductivity in the thickness direction of the graphite film 4.

The thermal conductivity in the surface direction of the graphite film 4 is calculated using the following equation (1):

A=α×d×Cp (1)

where A represents the thermal conductivity in the surface direction of the graphite film 4, α represents the thermal diffusivity in the surface direction of the graphite film 4, d represents the density of the graphite film 4, and Cp represents the specific heat capacity of the graphite film 4. The density, the thermal diffusivity, and the specific heat capacity in the surface direction of the graphite film 4 are obtained in the following manner.

The density of the graphite film 4 is measured in the following manner: a sample measuring 100 mm×100 mm cut from the graphite film 4 is measured for weight and thickness; and the measured value of the weight is divided by the value of volume (calculated from 100 mm×100 mm×thickness).

The specific heat capacity of the graphite film 4 is measured with the use of a differential scanning calorimeter DSC220CU, which is a thermal analysis system manufactured by SII NanoTechnology Inc., in the condition in which temperature is raised from 20° C. to 260° C. at 10° C./min.

The thermal conductivity in the thickness direction of the graphite film 4 can be calculated in the same manner as described above using the foregoing equation (1), except that a in the equation is the thermal diffusivity in the thickness direction of the graphite film 4.

In a case where the thickness of the graphite film 4 is greater than 3 μm, the thermal diffusivity in the surface direction of the graphite film 4 can be measured with the use of a commercially-available thermal diffusivity measuring instrument using a light alternating-current method (for example, “LaserPIT” available from ULVAC RIKO, Inc.) in the following manner, for example: a sample measuring 4 mm×40 mm cut from the graphite film 4 is measured in an atmosphere of 20° C. at a laser frequency of 10 Hz. On the other hand, in a case where the thickness of the graphite film 4 is equal to or less than 3 μm, the thermal diffusivity in the surface direction of the graphite film 4 is difficult to accurately measure with the use of a commercially-available instrument, and thus is measured by a newly developed periodical heating method.

The thermal diffusivity in the thickness direction of the graphite film 4 is determined by a pulse heating method using a laser. In this method, a laser is shined on one surface of the film and thereby the film is heated, and thereafter a temperature response (temperature change) at the opposite surface of the film is measured. Then, half-time (t_{1/2}) of time (t) taken for the temperature to reach a certain temperature is calculated using the following equation (2):

$$α = \frac{{d}^{2}}{{τ}_{0}} = 0.1388 \times \frac{{d}^{2}}{{t}_{1 / 2}} \qquad ( 2 )$$

where α represents thermal diffusivity, τ₀ represents the period of thermal diffusion, d represents the thickness of a sample, t_{1/2} represents half-time, and 0.1388 is the apparatus constant of the apparatus used.

(Thickness of Graphite Film 4)

The thickness of the graphite film 4 in Embodiment 1 is 1 μm or greater and 100 μm or less, more preferably 2 μm or greater and 100 μm or less, particularly preferably 10 μm or greater and 100 μm or less. A graphite film 4 having such a thickness has a sufficient mechanical strength to serve as a substrate, and provides high thermal conductivity characteristics in the surface direction (equal to or greater than 1500 W/mK).

The thickness of the graphite film 4 is measured in the following manner: thicknesses at any ten locations of a sample measuring 50 mm×50 mm cut from the graphite film 4 are measured in a thermostatic chamber at 25° C. with the use of a thickness gage (HEIDENHAIN-CERTO, manufactured by HEIDENHAIN); and the mean of the thicknesses is used as the thickness of the graphite film 4.

(Electric Conductivity in Surface Direction of Graphite Film 4)

The electric conductivity in the surface direction of the graphite film 4 in Embodiment 1 is preferably 16000 S/cm or greater, preferably 17000 S/cm or greater, most preferably 18000 S/cm or greater.

Furthermore, the graphite film 4 preferably has anisotropy (orientation) such that the electric conductivity in the surface direction of the graphite film 4 is equal to or greater than 100 times the electric conductivity in the thickness direction of the graphite film 4.

The electrical conductivity of the graphite film 4 is measured by applying a constant current in a four-point probe method (for example, by using Loresta-GP, manufactured by Mitsubishi Chemical Analytech Co., Ltd.)

(Density of Graphite Film 4)

The graphite film 4 preferably has a higher density, because a higher density provides better self-supporting property and better mechanical strength characteristics. Furthermore, a graphite film 4 having a greater density causes a greater interaction with a charged particle beam, and thus provides a greater neutron decelerating effect. In addition, a graphite film 4 having a high density has little gap between its constituent graphite layers, and therefore such a graphite film 4 tends to have a high thermal conductivity. In a case where a graphite film 4 has a low density, such a graphite film 4 has a poor efficiency in decelerating a charged particle beam, and, in addition, the graphite film 4 also has a decreased thermal conductivity due to the effects of air layers between the constituent graphite layers. This is therefore not preferred. It is also inferred that, in the air layers (hollow portions), thermal conductivity is poor and thus heat is likely to be trapped in these portions, or that the air layers in the hollow portions expand due to temperature increase caused by heat. Therefore, a graphite film 4 having a low density easily deteriorates and/or is damaged. In view of these matters, the graphite film 4 preferably has a high density. Specifically, the density is preferably 1.60 g/cm³ or greater, preferably 1.70 g/cm³ or greater, more preferably 1.80 g/cm³ or greater, more preferably 2.00 g/cm³ or greater, most preferably 2.10 g/cm³ or greater. In regard to the upper limit of the density of the graphite film 4, the density of the graphite film 4 is 2.26 g/cm³ (theoretical value) or less, and may be 2.25 g/cm³ or less.

The density of the graphite film 4 is measured in the following manner: a sample measuring 100 mm×100 mm cut from the graphite film 4 is measured for weight and thickness; and the measured value of the weight is divided by the value of volume (calculated from 100 mm×100 mm×thickness).

(Mechanical Strength of Graphite Film 4)

The mechanical strength of the graphite film 4 can be estimated by performing an MIT folding endurance test on the graphite film 4, in a case where the graphite film 4 is equal to or less than 100 μm in thickness. The number of times the graphite film 4 is folded in the MIT folding endurance test may be preferably 500 or more, more preferably 1000 or more, even more preferably 2000 or more. The MIT folding endurance test for the graphite film 4 is carried out in the following manner. Three test pieces each measuring 1.5 ×10 cm are removed from the graphite film 4. The test is carried out with the use of an MIT crease-flex fatigue resistance tester Model D manufactured by Toyo Seiki Seisaku-sho, Ltd. under the conditions in which test load is 100 gf (0.98 N), speed is 90 times/min., and radius of curvature R of folding clamp is 2 mm. The graphite film 4 is folded to an angle of 135° in either direction in an atmosphere of 23° C., and the number of times the graphite film 4 is folded before the graphite film 4 is severed is counted.

It should be noted that, in Embodiment 1, a graphite substrate equal to or greater than 100 μm in thickness has a sufficient mechanical strength and thus mechanical strength is not an issue.

(Configuration of Target)

As illustrated in FIG. 1, the target (A) in accordance with Embodiment 1 is structured such that a surface of the metal film 3 and a surface of the graphite film 4 constitute the interface between the metal film 3 and the graphite film 4. That is, the target (A) is structured such that the graphite film 4 and the metal film 3 are directly joined together. Such a structure can be prepared, for example, in a case where the metal film 3 is relatively thick, by coating beryllium on one side of the graphite film 4 by hot pressing, HIP, or the like. In a case where the metal film 3 is relatively thin beryllium, the structure can be prepared by, for example, forming beryllium on one side of the graphite film 4 by vapor deposition.

FIG. 2 is a cross-sectional view illustrating a variation of the target in accordance with Embodiment 1. As illustrated in FIG. 2, a target (B), which is Variation 1, has a target support frame 5. The target support frame 5 is a frame that supports at least the peripheral portion of the graphite film 4, and is preferably composed of a metal because the metal has excellent mechanical strength, excellent thermal conductivity, and excellent durability.

As described above, the target (B) of Variation 1 is supported by the target support frame 5. This makes it possible to achieve a cartridge-type structure (cassette-type structure) that makes the target (B) easily attachable/detachable. Furthermore, in a case where the target support frame 5 is composed of a metal, heat generated in the target (B) can be easily guided through the target support frame 5 to a separately provided cooling mechanism.

FIG. 3 is a cross-sectional view illustrating another variation of the target in accordance with Embodiment 1. As illustrated in FIG. 3, a target (C), which is Variation 2, has a target support frame 5 that has therein a coolant flow channel 6 serving as a cooling mechanism. A coolant for passage through the coolant flow channel 6 is a liquid with a high thermal conductivity such as cooling water, or a gas.

As described above, since the target support frame 5 has the coolant flow channel 6 therein, heat generated in the target (C) is quickly cooled by the coolant flow channel 6 serving as a cooling mechanism provided in the target support frame 5. This improves the durability of the target (C) and also improves nuclear reaction efficiency.

FIG. 4 is a cross-sectional view illustrating a further variation of the target in accordance with Embodiment 1. As illustrated in FIG. 4, a graphite film 4 in a target (D), which is Variation 3 in accordance with Embodiment 1, may have its exposed outer surface entirely coated with a metal material film 7 that is resistant to radiation and corrosion, depending on need. A material for the metal material film 7 is, for example, titanium or the like. According to the configuration illustrated in FIG. 4, when the target (D) is entirely placed in vacuum, the target (D) is prevented from undergoing oxidative degradation in oxidizing atmosphere that is caused by contact with air.

(Energy of Accelerated Proton Beam and Heat Generation)

In the targets (A) to (D) and in a target (E) of Embodiment 2 (described later), protons (charged particles) pass through the graphite film 4. In this regard, the collision stopping power (energy loss) of a target material (in this case, the graphite film 4) for a charged particle (proton) is represented by the following Bethe equation (equation (3)):

$${S}_{col} = - \frac{4 π {e}^{4} {z}^{2} N}{{mv}^{2}} Z [ ln \frac{2 {mv}^{2}}{I ( 1 - {β}^{2} )} - {β}^{2} ] \qquad ( 3 )$$

where e represents elementary charge of electron, m represents mass of electron, v represents velocity of electron, z represents nuclear charge of incident particle, Z represents the atomic number of the target material, N represents the number of atoms per unit volume of the target material, I represents the mean excitation potential of the target material, and β represents v/c where c is the speed of light.

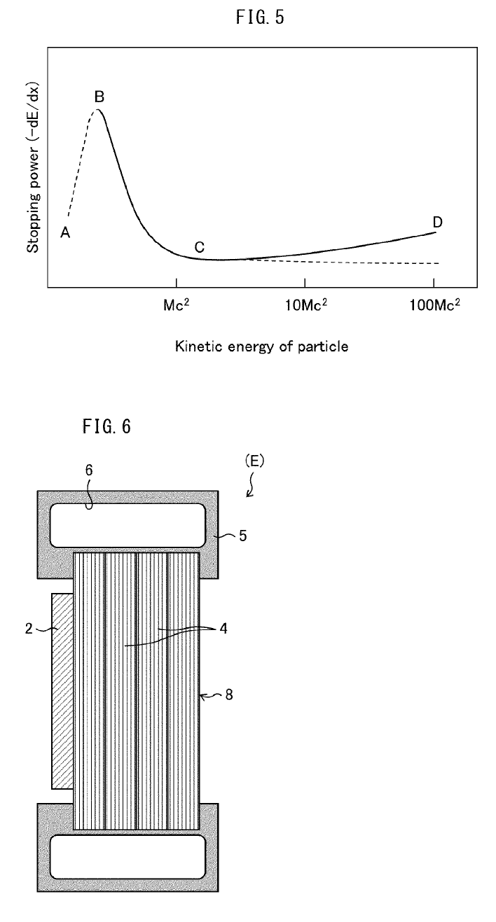

FIG. 5 is a graph showing the relationship between the stopping power based on the Bethe equation (equation (3)) and kinetic energy of particle. As illustrated in FIG. 5, the collision stopping power (energy loss) of a target material for a charged particle increases from A (kinetic energy of particle is low) to B and reaches maximum at B. Then, the stopping power decreases from B to C in proportion to I/v², and reaches minimum at C. Then, the stopping power gradually increases from C to D, where logarithms of the Bethe equation (equation (3)) are effective.

Protons, which are for use in the present invention, form a charged particle beam falling within the energy range of from B to C, which is a relatively low energy range. The energy of the charged particle beam at B is on the order of MeV (for example, 2 MeV), and the energy of the charged particle beam at C is on the order of GeV (for example, 3 GeV). The stopping power of the target material at B is about 100 times as high as the stopping power of the target material at C.

In the energy range of from 1 to 100 MeV in which a small accelerator for cancer therapy or boron neutron capture therapy (BNCT), which are major applications of the present invention, is used, the stopping power decreases as the particle energy increases. Therefore, lower-energy particles, after entering a target, lose energy and turn into heat within a narrow target region. That is, the heat load that the substrate experiences, per unit volume of the target, in the low-energy region where the stopping power is large is larger than the heat load resulting from particle irradiation in the high-energy range. That is, the heat generation caused by irradiation with an accelerated proton beam is not reduced even when the energy of the accelerated proton beam is small, and therefore, even in the case of irradiation with a low-energy proton beam, the target is required to have high durability.

(Method of Generating Neutron)

A method of generating neutrons in accordance with Embodiment 1 involves generating low-energy neutrons with a reduced amount of fast neutrons that are harmful and that have the high ability to cause radioactivation, through collision of low-energy protons with a target in vacuum. The target used in Embodiment 1 is a substrate constituted by: a graphite film 4 having the foregoing properties; and a metal film 3 that is attached to one side of the graphite film 4 and that is equal to or greater than 10 μm and less than 1 mm in thickness. With this arrangement, the method of generating neutrons in accordance with Embodiment 1 is capable of reducing the level of radioactivation as compared to heavy metals and is capable of reducing the generation efficiency of low-energy neutrons with a recued amount of fast neutrons that are harmful and that have the high ability to cause radioactivation. Furthermore, since the heat load associated with nuclear reactions can be reduced by the graphite substrate, the cooling mechanism can be reduced in size.

In a case where the metal film 3 is composed of beryllium, the energy of accelerated proton for use in the method of generating neutrons in accordance with Embodiment 1 is preferably equal to or greater than 3 MeV and less than 11 MeV, more preferably equal to or greater than 4 MeV and equal to or less than 8 MeV. The energy of accelerated proton for use in an embodiment of the present invention is preferably equal to or greater than 3 MeV, because, if the energy of accelerated proton is less than 3 MeV, the generation efficiency of neutrons dramatically decreases. On the other hand, the energy of accelerated proton is preferably less than 11 MeV, because, if the energy of accelerated proton is equal to or greater than 11 MeV, this may cause not only a dramatic radioactivation of members but also generation of a large amount of fast neutrons, generation of by-product radioactive substances such as highly toxic tritium, and the like. The energy of accelerated proton is preferably equal to or greater than 4 MeV and equal to or less than 8 MeV in order to reduce the extent of radioactivation of members and to selectively generate low-energy neutrons with a recued amount of fast neutrons that are harmful and that have the high ability to cause radioactivation.

In a case where the metal film 3 is composed of lithium, the energy of accelerated proton for use in the method of generating neutrons in accordance with Embodiment 1 is preferably equal to or greater than 2 MeV and equal to or less than 4 MeV. Since the threshold for the ⁷Li(p,n) reaction of lithium is about 2 MeV, an energy of accelerated proton less than 2 MeV causes a dramatic decrease in neutron generation efficiency. On the other hand, the energy of accelerated proton is preferably equal to or less than 4 MeV, because an energy of accelerated proton more than 4 MeV not only causes members to become radioactive to a great extent but also causes generation of a large amount of fast neutrons.

In the method of generating neutrons in accordance with Embodiment 1, collision of protons with a target is carried out in vacuum.

In Embodiment 1, it is preferable that a surface of the metal film 3, that is, the surface located at a target's surface, is arranged so as to face the direction of travel of proton. This is in order to allow a nuclear reaction between proton and metal to take place first.

Neutrons that can be generated by the method of generating neutrons in accordance with Embodiment 1 are low-energy neutrons including large amounts of thermal neutrons or epithermal neutrons. Low-energy neutrons refer to neutrons with a reduced amount of fast-neutrons that are harmful and that have the high ability to cause radioactivation. Fast neutrons are 100 times or more as high in energy as thermal neutrons or epithermal neutrons, and therefore are biologically harmful and have the very high ability to cause radioactivation. Neutron is categorized into fast neutron, epithermal neutron, thermal neutron, and cold neutron. These kinds of neutron are not definitely categorized in terms of energy, and the energy categories are different among the fields such as reactor physics, shielding, dosimetry, analyses, and medical fields. For example, Basic Terminology for Nuclear Disaster Prevention (Genshiryoku bousai kiso yougo) states that “Among neutrons, those with large momentum are called fast neutrons. Generally, neutrons of 0.5 MeV or greater are referred to as fast neutrons, although this value varies among fields such as reactor physics, shielding, or dosimetry”. On the other hand, in medical fields, epithermal neutron usually refers to neutron falling within the energy range of from 1 eV to 10 keV, whereas thermal neutron usually refers to neutron falling within the energy range of equal to and less than 0.5 eV. The term “low-energy neutron” as used in the present invention refers to neutron with a reduced amount of fast neutron of 0.5 MeV or greater. When the energy of incident proton is greater than 8 MeV, neutron of 5 MeV or greater may be contained; however, the amount of such neutron can be reduced significantly as compared to conventional primary neutron.

(Neutron Generator)

A neutron generator in accordance with Embodiment 1 includes a target, a hydrogen ion generator, a linear accelerator, and a proton emitting section. An accelerator for generating protons in a neutron generator is a linear accelerator. In conventional techniques, a large accelerator such as a synchrotron or a cyclotron is used in order to use, as proton for collision with a target, high-energy proton of 11 MeV or greater. In Embodiment 1, mainly used proton is equal to or greater than 2 MeV and less than 11 MeV. Therefore, a linear accelerator is sufficient to generate desired large-current proton.

The linear accelerator includes the hydrogen ion generator at one end thereof. Hydrogen ions from the hydrogen ion generator enter an acceleration cavity through a charged particle converting film and are accelerated.

The hydrogen ion generator is not particularly limited, and can be, for example, a conventional proton generator, a conventional negative hydrogen ion generator, or the like. The acceleration cavity can be a radio frequency accelerating cavity, a DC acceleration cavity, a normal conducting accelerating cavity, a superconducting accelerating cavity, or the like.

The proton beam emitting section is provided on the opposite side of the linear accelerator from the hydrogen ion generator. The proton beam emitting section is provided between the linear accelerator and the target. The proton emitting section is not particularly limited, and can be a conventional proton emitting section that includes a quadrupole electromagnet and a bending magnet.

The protons accelerated by the linear accelerator are guided to the proton emitting section connected at an end of the linear accelerator, and collide with the target at an end of the proton emitting section. Through this collision, low-energy neutrons are generated.

As has been described, the targets (B) to (D) each include a metal film 3, a graphite film 4, and a target support frame 5 that has a cooling function. This makes it possible to obtain a cartridge-type structure in which the metal film 3, the graphite film 4, and the target support frame 5 are joined together. The neutron generator in accordance with Embodiment 1 may employ the following arrangement: a target (B), (C), or (D), which has a cartridge-type structure, is provided at an end of the proton emitting section with a vacuum flange therebetween which has a semiautomatic detach/attach structure. This makes it possible to easily replace a deteriorated target with a new target by detaching the deteriorated target and attaching the new target via remote control.

Furthermore, with respect to the targets (A) to (D), low-energy proton beams can be used, and therefore generation of harmful fast neutron is reduced. It is therefore possible, in Embodiment 1, to reduce the size of a deceleration mechanism for decelerating generated neutrons. Thus, a neutron generator in accordance with Embodiment 1 can also be installed in small-scale medical institutions as a medical neutron generator for generation of neutron for medical purposes such as BNCT.

Furthermore, if it is possible to obtain a target substrate much thinner than conventional target substrates, it will be possible to generate neutrons with the use of a smaller accelerator (that is, with the use of a proton beam accelerated only to an energy lower than conventional). Neutrons generated using such low-energy protons do not contain fast neutrons that are harmful in cancer therapy. Therefore, with a target of an embodiment of the present invention, it is possible to generate low-energy thermal and epithermal neutrons that are useful in cancer therapy while reducing the extent of radioactivation of the target. Such characteristics of an embodiment the present invention are innovative as a neutron generation target for cancer therapy.

### Embodiment 2

The following description will discuss another embodiment of the present invention with reference to FIG. 6. FIG. 6 is a cross-sectional view schematically illustrating a configuration of a target (E) in accordance with Embodiment 2. As illustrated in FIG. 6, the target (E) in accordance with Embodiment 2 is different from the foregoing Embodiment 1 in that a substrate that supports a metal film 3 is a graphite stack 8 constituted by graphite films 4 stacked together. In a case where the energy of an accelerated proton beam with which the target (E) is irradiated is relatively high and the quantity of heat generated by irradiation with the beam is extremely large, a substrate that supports a metal film 3 may be constituted by a graphite stack 8 as described in Embodiment 2.

The thickness of each of the graphite films 4 is equal to or greater than 1 μm and equal to or less than 100 μm. The graphite stack 8 can be prepared by uniting a plurality of graphite films 4 by heating the graphite films 4 under pressure or by uniting a plurality of graphite films 4 by pressing the graphite films 4 under heat. That is, the graphite stack 8 is a laminate of a plurality of graphite films 4 united together by means of pressure or heat. Since the substrate that supports the metal film 3 is constituted by the graphite stack 8 as described above, durability and heat resistance against proton beam irradiation improve.

The thickness of the graphite stack 8, which serves as a target substrate, is equal to or greater than 100 μm and equal to or less than 20 mm, more preferably equal to or greater than 200 μm and equal to or less than 10 mm.

The target (E) in accordance with Embodiment 2 also preferably has a target support frame 5 attached thereto as illustrated in FIG. 6, depending on need. The target support frame 5 has a flow channel 6 serving as a cooling mechanism.

By the way, stacking a plurality of graphite films 4 like Embodiment 2 is useful in a case where the energy of an accelerated proton beam is relatively high. If the energy of an accelerated proton beam is high and a target is too thin, the proton beam unintentionally passes through the target. This not only dramatically reduces neutron generation efficiency but also causes mixing of generated neutrons and a proton beam, and thus is not preferred. Furthermore, even in a case where the proton beam is shielded against, fast neutrons that are harmful in medical applications such as cancer therapy may be mixed in the generated neutrons if neutron generation is carried out using a high-energy proton beam. The target substrate in some cases serves also to decelerate such neutrons, and therefore a target for neutron generation is required to have a thickness that is suitable for the energy of a proton beam with which the target is irradiated and that is suitable for the intended purpose of generated neutrons.

In Embodiment 2, the graphite stack 8 is prepared by stacking together a plurality of graphite films 4 each having a thickness in the range of from 1 μm to 100 μm. Therefore, thermal conductivity or electric conductivity characteristics are basically not lost, and basically a target substrate of any thickness can be prepared. Embodiment 2 thus provides a very superior method.

(Method of Laminating by Press Bonding)

A method of preparing a substrate of a desired thickness by stacking a plurality of graphite films 4 is not particularly limited. In consideration that the substrate is exposed to extremely high temperature, it is preferable that the graphite stack 8 is formed by press-bonding a plurality of graphite films 4 by directly pressing and/or heating the graphite films 4 without use of adhesives. The conditions under which the graphite films 4 are pressed and/or heated are not limited, provided that the graphite films 4 constituting the resulting graphite stack 8 are sufficiently strongly united together, but the graphite films 4 are pressed and/or heated preferably in vacuum or in an inert gas such as argon or nitrogen under the conditions in which heating temperature is in the range of from 200° C. to 3000° C. and applied pressure is equal to or greater than 10⁴ pascals. Heating while pressing or pressing while heating is particularly preferred as a method of preparing a laminate. The graphite films 4 constituting the graphite stack 8 do not necessarily have to be fully graphitized, and may be films carbonized at a temperature equal to or above 600° C., more preferably equal to or above 800° C., most preferably equal to or above 1000° C. By stacking such carbonized films and, for example, heating the films and/or pressing the films at a temperature equal to or above 2800° C., it is possible to obtain a desired target substrate.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

[Recap]

A target in accordance with one embodiment of the present invention is a target including, at least: a metal film composed of a beryllium material or a lithium material; and a substrate constituted by a graphite film, the target being configured to generate a neutron upon collision of an accelerated proton with a surface of the metal film and a surface of the substrate, the graphite film having a thermal conductivity in a surface direction of 1500 W/(m·K) or greater, the thermal conductivity in the surface direction of the graphite film being equal to or greater than 100 times a thermal conductivity in a thickness direction of the graphite film, the graphite film having a thickness of 1 μm or greater and 100 μm or less.

According to the above arrangement, the substrate is constituted by a graphite film. This makes it possible to reduce the extent of radioactivation of the substrate. Furthermore, the graphite film has a thermal conductivity in a surface direction of 1500 W/(m·K) or greater, and the thermal conductivity in the surface direction of the graphite film is equal to or greater than 100 times a thermal conductivity in a thickness direction of the graphite film. This makes it possible to quickly transfer the heat generated by proton beam irradiation to a cooling section, and thus the substrate is sufficiently durable.

Furthermore, the graphite film has a thickness of 1 μm or greater and 100 μm or less. A graphite film having such a thickness is mechanically strong enough to serve as a substrate that supports a metal film despite its very small thickness.

Furthermore, with the use of such a thin target, it is possible to generate low-energy thermal and epithermal neutrons that are suitable for medical purposes, using a proton beam which has been accelerated only to an energy lower than conventional beams and which causes less radioactivation.

The target in accordance with one embodiment of the present invention is preferably arranged such that: the graphite film has an electric conductivity in the surface direction of 16000 S/cm or greater; and the electric conductivity in the surface direction of the graphite film is equal to or greater than 100 times an electric conductivity in the thickness direction of the graphite film.

The measurement of electric conductivity is very easy as compared to the measurement of thermal conductivity characteristics, and electric conductivity characteristics are well proportional to thermal conductivity characteristics. It is therefore possible to appropriately manage the performance of a graphite film as a substrate by measurement of electric conductivity characteristics.

The target in accordance with one embodiment of the present invention is preferably arranged such that: the substrate is constituted by a graphite stack which is a plurality of the graphite films stacked together; and the substrate is equal to or greater than 100 μm and equal to or less than 20 mm in thickness.

According to the above arrangement, the substrate is constituted by a graphite stack which is a plurality of the graphite films stacked together. This makes it possible to obtain a thicker substrate without losing thermal conductivity characteristics. Such a substrate constituted by a plurality of graphite films is sufficiently durable despite its thickness smaller than conventional substrates composed of isotropic graphite. This improves durability and heat resistance against irradiation with relatively high-energy proton beams, and is capable of not only neutron generation using proton beams in the energy ranges currently used only in medical applications but also neutron generation using higher-energy proton beams.

The target in accordance with one embodiment of the present invention is preferably arranged such that the graphite stack is a laminate obtained by uniting the plurality of graphite films by heating the plurality of graphite films under pressure or a laminate obtained by uniting the plurality of graphite films by pressing the plurality of graphite films under heat.

This makes it possible to obtain a thick substrate without having to use an adhesive or the like. Thus, durability and heat resistance against proton beam irradiation improve, and reduced radioactivation is achieved.

The target in accordance with one embodiment of the present invention is preferably arranged such that the graphite film is equal to or greater than 1.60 g/cm³ and equal to or less than 2.26 g/cm³ in density.

The target of an embodiment of the present invention is preferably structured such that the graphite film and the metal film are directly joined together. In other words, it is preferable that the target includes a metal film that is composed of a metal and that is stacked on the graphite film. As used herein, the term “metal film that is composed of a metal and that is stacked on the graphite film” refers to a metal film directly joined to the graphite film.

The target in accordance with one embodiment of the present invention preferably has a support frame that supports the target.

According to the above arrangement, the target has a support frame that supports the target. This improves the mechanical strength and durability of the target.

The target in accordance with one embodiment of the present invention is preferably arranged such that the support frame includes a cooling mechanism for cooling the target.

With this arrangement, when heat is generated in the target by proton beam irradiation, the target is quickly cooled by the cooling mechanism of the support frame. Accordingly, the durability of the target improves and also nuclear reaction efficiency improves.

A neutron generator in accordance with one embodiment of the present invention includes: an accelerator configured to accelerate a proton; and a proton emitting section configured to emit, toward the foregoing target, the proton accelerated by the accelerator.

With this arrangement, it is possible to obtain a neutron generator that is sufficiently durable and heat-resistant against proton beam irradiation and that can reduce the extent of radioactivation.

A method of producing a target in accordance with one embodiment of the present invention is a method of producing a target that includes: a metal film composed of a beryllium material or a lithium material; and one or more graphite films composed of graphite, the target being configured to generate a neutron upon collision of a proton with a surface of the metal film and a surface of the graphite film, the method including a step of preparing the one or more graphite films by firing one or more polymeric films.

By firing a polymeric film like the above arrangement, it is possible to obtain a graphite film that has the foregoing characteristics (thermal conductivity, electric conductivity, mechanical strength, and the like) and that has a thickness in the range of from 1 μm to 100 μm. This makes it possible to provide a method of producing a target that is sufficiently durable and heat-resistant against proton beam irradiation and that can reduce the extent of radioactivation.

### INDUSTRIAL APPLICABILITY

The present invention can be used in, for example, a medical neutron generator for generation of neutron for medical purposes such as BNCT.

### REFERENCE SIGNS LIST

1 Proton beam (proton)
2 Neutron
3 Metal film
4 Graphite film (substrate)
5 Target support frame (support frame)
6 Coolant flow channel (cooling mechanism)
7 Metal material film
8 Graphite stack
(A) to (E) Target

1. A target comprising:
a metal film composed of a beryllium material or a lithium material; and
a substrate constituted by a graphite film,
wherein the target is configured to generate a neutron upon collision of an accelerated proton with a surface of the metal film and a surface of the substrate,
wherein the graphite film has a thermal conductivity in a surface direction of 1500 W/(m·K) or greater,
wherein the thermal conductivity in the surface direction of the graphite film is equal to or greater than 100 times a thermal conductivity in a thickness direction of the graphite film, and
wherein the graphite film has a thickness of 1 μm or greater and 100 μm or less.

2. The target according to claim 1, wherein the graphite film has an electric conductivity in the surface direction of 16000 S/cm or greater, and
wherein the electric conductivity in the surface direction of the graphite film is equal to or greater than 100 times an electric conductivity in the thickness direction of the graphite film.

3. The target according to claim 1, wherein the substrate is constituted by a graphite stack which is a plurality of the graphite films stacked together; and
wherein the substrate is equal to or greater than 100 μm and equal to or less than 20 mm in thickness.

4. The target according to claim 3, wherein the graphite stack is a laminate obtained by uniting the plurality of graphite films by heating the plurality of graphite films under pressure or a laminate obtained by uniting the plurality of graphite films by pressing the plurality of graphite films under heat.

5. The target according to claim 1, wherein the graphite film has a density that is equal to or greater than 2.00 g/cm³ and equal to or less than 2.26 g/cm³.

6. The target according to claim 1 wherein the target is structured such that the graphite film and the metal film are directly joined together.

7. The target according to claim 1, further comprising a support frame that supports the target.

8. The target according to claim 7, wherein the support frame includes a cooling mechanism for cooling the target.

9. A neutron generator comprising:
an accelerator configured to accelerate a proton; and
a proton emitting section configured to emit, toward the target recited in claim 1, the proton accelerated by the accelerator.

10. A method of producing a target that includes: a metal film composed of a beryllium material or a lithium material; and one or more graphite films composed of graphite, the target being configured to generate a neutron upon collision of a proton with a surface of the metal film and a surface of the graphite film, the method comprising
a step of preparing the one or more graphite films by firing one or more polymeric films.

11. The target according to claim 1, wherein the thermal conductivity in the surface direction of the graphite film is 1700 W/(m·K) or greater.

12. The target according to claim 2, wherein the electric conductivity in the surface direction of the graphite film is 18000 S/cm or greater.

13. The target according to claim 1, wherein the number of times the graphite film is folded in an MIT folding endurance test is 1000 or more.
